(19) United States
(12) Patent Application Publication
(10) Pub. No.: US 2024/0123751 A1
(43) Pub. Date: Apr. 18, 2024

(54) INFORMATION MEDIUM AND METHOD FOR PRODUCING INFORMATION MEDIUM

(71) Applicant: Phoenix Contact GmbH & Co. KG

(72) Inventors: Manuela Paus, Muenster (DE); Michael Peter, Lage (DE)

(21) Appl. No.: 17/768,229

(22) PCT Filed: Oct. 2, 2020
(86) PCT No.: PCT/EP2020/077652

§ 371 Date: Apr. 12, 2022

(30) Foreign Application Priority Data
Oct. 21, 2019 (LU) 101475

(51) Int. Cl. B41M 5/52; B41M 5/00; B41M 7/00

(52) U.S. Cl. CPC B41M 5/529; B41M 5/0011; B41M 7/0081

(57) ABSTRACT

An information medium includes: a base body, which has a surface that is printable at least in sections with a printing layer for displaying information. An adhesion-promoting layer is arranged on at least some sections of the surface. In an embodiment, the base body is inorganic. In an embodiment, the adhesion-promoting layer includes a molecular compound with a first functional group for binding to the surface and a second functional group for binding to the printing layer.

### CROSS-REFERENCE TO PRIOR APPLICATIONS

This application is a U.S. National Phase application under 35 U.S.C. § 371 of International Application No. PCT/EP2020/077652, filed on Oct. 2, 2020, and claims benefit to Luxembourg Patent Application No. LU101475, filed on Oct. 21, 2019. The International Application was published in German on Apr. 29, 2021 as WO 2021/078494 under PCT Article 21(2).

### FIELD

The invention relates to an information medium and to a method for producing an information medium.

### BACKGROUND

Such an information medium comprises a base body. A surface of the base body is provided to be printable on at least some sections with a printing layer for displaying information.

The base body can be designed as an (identification) plate, for example. The plate can have a disk-shaped shape. The surface can be a front or rear side of the base body. The base body can in particular be provided to be arranged on an electrical or electronic article.

It is known to apply a printing layer directly onto the base body. The printing layer can be applied to the base body with, for example, pad printing or an inkjet printing method. The disadvantage here is that the printing layer can detach from the base body under certain ambient conditions, such as high temperatures, high air humidity, or high pressures, or due to aging.

It is therefore desirable to provide an information medium which enables a durable connection between the printing layer and the base body.

### SUMMARY

In an embodiment, the present invention provides an information medium, comprising: a base body, which has a surface that is printable at least in sections with a printing layer for displaying information, wherein an adhesion-promoting layer is arranged on at least some sections of the surface.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a view of an information medium with information depicted thereon; and

FIGS. 2A-F are views of method steps for producing an information medium.

### DETAILED DESCRIPTION

In an embodiment, the present invention provides an information medium having a base body which has a surface on which a printing layer can adhere permanently and in a resistant manner.

In an embodiment, the present invention provides an information medium having the features described herein.

Accordingly, an adhesion-promoting layer is arranged on at least some sections of the surface of the base body.

The adhesion-promoting layer can be provided for promoting adhesion between the surface and the printing layer. Due to the adhesion-promoting layer, a printing layer can thus adhere permanently to the surface and be more resistant, e.g., to mechanical abrasion or chemical processes. In principle, the base body can be completely covered with the adhesion-promoting layer. For example, the surface or only a section of the surface can be covered with the adhesion-promoting layer. In particular, the base body can be covered on both sides with the adhesion-promoting layer. The section of the surface covered with the adhesion-promoting layer can be the section of the surface provided for printing with the printing layer.

In one embodiment, the base body is formed from an inorganic material. For example, the base body can consist of ceramic or glass.

In particular, the base body can be metallic. For example, the base body can consist of a non-rusting steel. The base body can be corrosion-resistant and/or acid-resistant. In one embodiment, the base body consists of a stainless steel—in particular, V2A or V4A. The base body can thus consist of a molybdenum stainless steel. In particular, the base body can be alloyed with 2% molybdenum, so that the base body is particularly resistant to corrosion.

A shape of the base body is disk-shaped in one embodiment. A circumference of the base body can be many times greater than a thickness of the base body. In particular, the circumference of the base body can be circular. Other flat shapes, such as rectangular or polygonal, or shapes such as cuboids or spheres, are, naturally, also conceivable and possible. In principle, the base body can also be designed as a housing component for an electrical or electronic article.

The base body can have a fastening means for fastening to an electrical or electronic article. The fastening means can, for example, be an opening in the base body for feeding through a holding element.

In one embodiment, the adhesion-promoting layer has a molecular compound with a first functional group for binding to the surface and a second functional group for binding to the printing layer. The first functional group can, for example, be designed to be bonded to metal or glass. In particular, the first functional group can have a phosphate or silane group.

The second functional group can, for example, be designed to be bonded to a UV-curable fluid—in particular, one that is acrylate-based. In particular, the second functional group can have an acrylate group.

A binder for binding the first functional group to the second functional group can be arranged between the first functional group and the second functional group. The binder can have at least one methylene group, CH2. In one embodiment, the binder comprises a plurality of methylene groups, (CH2)n. The plurality of methylene groups can, for example, amount to 2, 3, 4, . . . , such that n can be n=0, 1, 2, 3, 4, . . . , wherein, in particular, for n=0, an embodiment with no binder and, for n=1, an embodiment with only one methyl group as the binder can be provided.

In one embodiment, the adhesion-promoting layer comprises a silicon compound. The silicon compound can be arranged on the first functional group. Molecules contained in the adhesion-promoting layer can thus have at least one silicon atom. In particular, the adhesion-promoting layer can comprise a silane compound.

In a further embodiment, the adhesion-promoting layer comprises at least one acrylate and/or at least one ester. The at least one type of acrylic and/or the at least one ester can be arranged on the second functional group. The acrylate can contain at least one silyl group. The silyl group can, for example, be a trimethylsilyl group or a trimethoxysilyl group.

In a further embodiment, the adhesion-promoting layer comprises at least one 3-(trimethoxysilyl)propyl acrylate. In particular, the adhesion-promoting layer can consist entirely of the 3-(trimethoxysilyl)propyl acrylate.

In one variant, the adhesion-promoting layer comprises at least one 3-(trimethoxysilyl)propyl methacrylate. In particular, the adhesion-promoting layer can comprise silane A174 or at least one chemical substance with CAS no. 2530-85-0. The adhesion-promoting layer can thus comprise the molecule H2C═C(CH3)CO2(CH2)3Si(OCH3)3 or

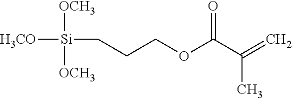 [SMILES: C=C(C)C(=O)OCCC[Si](OC)(OC)OC]

In particular, the adhesion-promoting layer can thus consist of a 3-(trimethoxysilyl)propyl methacrylate.

As stated above, the presence and length of the binder between the first and the second functional groups is arbitrary. The binder can be an n-propyl group. For example, the adhesion-promoting layer can comprise at least one molecule H2C═C(CH3)CO2(CH2)nSi(OCH3)3 or

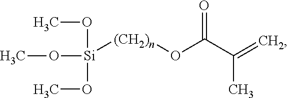

where n=0, 1, 2, 3, . . . can be a natural number or zero. Likewise, the adhesion-promoting layer can comprise at least one molecule H2C═C(CH3)CO2(CH2)nX(OCH3)3, where X can be X=Si, P, or another suitable element.

The adhesion-promoting layer can be hydrophilic. In one embodiment, the printing layer is formed from ink liquid. A contact angle of a droplet of the ink liquid applied to the adhesion-promoting layer of a metallic base body can be 60° to 80°, and in particular 68° to 69°.

For a base body made of an inorganic material, such as ceramic or glass, the contact angle can naturally assume any other values.

In one embodiment, a printing layer is bonded to the base body by the adhesion-promoting layer. The adhesion-promoting layer can thus promote adhesion between the base body and the printing layer. The adhesion between the base body and the printing layer can be resistant enough that the printing layer does not detach from the base body, particularly under IPX9K test conditions.

The printing layer can comprise in particular at least one acrylate. The printing layer can thus be acrylate-based. In particular, the printing layer can comprise at least one colorant. The at least one colorant can be an inorganic or organic colorant. The printing layer can also comprise at least one pigment and/or at least one dye. The printing layer can have, for example, a black, white, blue, red, or yellow color, or a mixture of different colors. In particular, the printing layer can comprise any color that can be generated with the CMYK color model.

In a further embodiment, the printing layer comprises a UV-curable fluid. In particular, the printing layer can comprise a UV-curable, acrylate-based fluid.

According to a second aspect, the aim is achieved by a method for producing an information medium having the features described herein.

This method comprises the following steps: In a first step, a base body is provided. In a second step, an adhesion-promoting layer is applied at least to sections of the base body. In a third step, a printing layer is applied at least to sections of the adhesion-promoting layer. In principle, the adhesion-promoting layer can be applied to the entire base body. A section of the base body can, for example, be a surface of the base body. The surface of the base body can in particular be one side of the base body. The printing layer can in principle be applied to the entire adhesion-promoting layer. In one embodiment, the entire base body is printed with the printing layer on the adhesion-promoting layer.

It is also conceivable and possible to apply the adhesion-promoting layer to at least one section of the base body, to print the printing layer onto the entire base body, and to then remove the printing layer from sections of the base body that do not have an adhesion-promoting layer. The printing layer can be removed from sections of the base body which do not have an adhesion-promoting layer—for example, by mechanical or chemical methods. Methods of this type include, for example, heat storage—in particular, at above 250° C.—climate-controlled storage—in particular, at above 85° C. and above 85% relative air humidity—heating, and high-pressure cleaning with a water jet—in particular, heated above 80° C.

In one embodiment, the base body is cleaned with a solvent before the application of the adhesion-promoting layer. The cleaning with the solvent can serve, for example, to pre-clean the base body. As a result, the base body can be freed of impurities such as fibers and grease—in particular, organic impurities. If the base body is sufficiently clean, the pre-cleaning can be dispensed with. The solvent can be isopropanol, for example. Alternatively or additionally, the base body can be pre-cleaned in an ultrasonic bath or a similar device.

In a further embodiment, the base body is treated with at least one plasma before the application of the adhesion-promoting layer. In particular, the surface onto which the adhesion-promoting layer is to be applied can be treated with the at least one plasma. In the medical field, the treatment with the at least one plasma can optionally be dispensed with due to the cleanliness which is present in any case. In general, plasma cleaning may be omitted if the pre-cleaning (for example, in the ultrasonic bath) has already removed all impurities.

The treatment with the at least one plasma can comprise a treatment with any type of plasma that can be based upon a cleaning gas—in particular, also hydrogen, water, argon, or nitrogen plasma. In one embodiment, a treatment of the surface with an oxygen plasma, i.e., an O₂ plasma, is provided. The treatment with the oxygen plasma can enable fine cleaning of the base body—in particular, the surface to which the adhesion-promoting layer is to be applied.

The treatment with the at least one plasma can, alternatively or additionally, comprise a treatment with a water plasma, i.e., an H₂O plasma. The treatment with the water plasma can enable plasma activation of the base body—in particular, the surface to which the adhesion-promoting layer is to be applied. The plasma activation can prepare the surface for the application of the adhesion-promoting layer.

The treatment with the oxygen plasma can be carried out within a shorter process time than the treatment with the water plasma.

In principle, the treatment with the at least one plasma can be carried out in a vacuum. The application of the adhesion-promoting layer at least to sections of the base body can also be carried out in a vacuum. In particular, the vacuum cannot be interrupted between the treatment with the at least one plasma and the application of the adhesion-promoting layer. The treatment with the at least one plasma and the application of the adhesion-promoting layer to sections of the base body can be carried out in a common vacuum chamber. In one embodiment, the plasma treatment takes place in a furnace without interruption of the vacuum, so that the base body to be treated does not necessarily have to be removed in the meantime. Removal of the base body from the furnace can take place only after the treatment process has been completely carried out. Vacuum in this context can be understood to mean a pressure in the range 0.3 bar to 1 pbar, and in particular 0.1 mbar to 0.5 mbar or 0.1 mbar to 0.3 mbar.

In one embodiment, the adhesion-promoting layer is applied by vapor deposition—in particular, plasma polymerization. For this purpose, a plasma system—in particular, a low-pressure plasma system—can be used. The plasma system can have a frequency generator—in particular, a low-frequency generator or a high-frequency generator—for forming an activation plasma. The frequency generator can be operated, for example, with frequencies in the range of 30 kHz to 15 MHz, and in particular at 40 kHz or 13.56 MHz. In particular, the treatment with the at least one plasma—which can, for example, constitute cleaning—formation of the activation plasma, and application of the adhesion-promoting layer by plasma coating can be carried out in a common process step. Different plasmas can be used for the treatment with the at least one plasma and for the application of the adhesion-promoting layer. For example, a plasma based upon a coating gas and, optionally, additionally an activation plasma based upon an activation gas can be used for the application of the adhesion-promoting layer.

The adhesion-promoting layer can be applied to the surface in sections by arranging a mask with openings on the surface. The adhesion-promoting layer can be applied to sections of the surface which correspond to openings of the mask. No adhesion-promoting layer can be formed on sections of the surface which are covered by the mask. Due to the application of the adhesion-promoting layer on sections, a pearling-off effect, which can be used, for example, in medical devices, can be achieved at predetermined sections of the surface. In addition, the attachment, e.g., of a non-positively-connected handle, such as a rubber grip, can also be simplified at predetermined sections. By applying the adhesion-promoting layer in sections, predetermined sections can be cut out in a targeted manner in order, for example, to keep a transparent field of view free of the adhesion-promoting layer in the case of a base body made of glass.

A starting material for forming the adhesion-promoting layer—in particular, a monomer, e.g., 3-(trimethoxysilyl)propyl methacrylate—can, for the plasma polymerization, be provided in the form of a vapor or gas. The starting material can be activated by the activation plasma. The activation makes it possible to produce ionized molecules of the starting material. The ionized molecules of the starting material can condense on the base body and form by polymerization the adhesion-promoting layer—in particular, a polymer, e.g., 3-(trimethoxysilyl)propyl methacrylate.

The application of the adhesion-promoting layer onto the base body can comprise silanization with a silicon compound—in particular, with 3-(trimethoxysilyl)propyl methacrylate. Silanization can thus be used to promote adhesion for the printing layer.

Simultaneously to the application of the adhesion-promoting layer to the information medium, a further adhesion-promoting layer can be applied to a glass body under the same conditions, i.e., in particular, in the same plasma system, as the application of the adhesion-promoting layer to information media. Thus, quality control of the application of the adhesion-promoting layer to the information medium is possible, without controlling the information medium itself, by controlling the adhesion-promoting layer on the glass body. The quality control can be carried out, for example, with a contact angle measurement. Here, the contact angle of a water drop on a surface of the glass body can be determined.

To prepare the quality control of the adhesion-promoting layer with contact angle measurement, a functional dependence between the contact angle on the glass body and the contact angle on the information medium is determined. To carry out the quality control, the (real) contact angle on the glass body is then measured, and the (imaginary) contact angle on the information medium is inferred on the basis of the functional dependence.

In one embodiment, between the application of the adhesion-promoting layer and the application of the printing layer, the information medium is stored for a period of more than one week—for example, seven weeks. Preferably, between the application of the adhesion-promoting layer and the application of the printing layer, the information medium can be stored for a period of several weeks. The information medium can also be stored over several months—in particular, between six and twelve months. In particular, the information medium can be stored at room temperature between the application of the adhesion-promoting layer and the application of the printing layer.

In one embodiment, between the application of the adhesion-promoting layer and the application of the printing layer, the information medium is stored with the adhesion-promoting layer covered. The adhesion-promoting layer can be covered, for example, with an at least single-layer film. The film can form a barrier between the adhesion-promoting layer and the environment. Optionally, several films can be provided for covering the adhesion-promoting layer. The information medium can also be welded—in particular, in a vacuum—for storage. The information medium can additionally be arranged in an outer box for storage.

In a third step, the printing layer can be applied with a printing device at least to sections of the adhesion-promoting layer. The printing device can comprise an inkjet printer, for example. The printing device can also comprise with an LED-UV technology.

In one embodiment, the printing layer is cured with UV light after application. In particular, the application of a printing layer can comprise an acrylate-based fluid being applied at least to sections of the adhesion-promoting layer. The fluid can then be cured with UV light. In one embodiment, the printing layer is cured with UV light in five cycles.

In particular, after the application of the printing layer, the information medium can be stored over an arbitrary period of time at temperatures above room temperature and increased relative humidity. For example, the information medium can be stored at a temperature between 50° C. and 150° C., e.g., 85° C., and a relative air humidity between 50% and 100%—for example, 85%. After the application of the printing layer, the information medium can be stored at a temperature in a range between 100° C. and 300° C.—for example, at 250° C. The storage of the information medium at increased temperature and/or increased relative air humidity can also comprise treatments or the execution of further method steps on the information medium. After the application of the printing layer, the information medium can be cleaned with a high-pressure water jet—in particular, with water at a temperature of 80° C. and higher. The mentioned treatments of the information medium are possible without the printing layer becoming detached from the information medium.

Furthermore, the printing layer can be resistant to scratches, wiping, storage in heat, storage under UV radiation, and storage in a salt mist. The printing layer can be resistant to corrosion—in particular, corrosion by sulfur dioxide—and, very particularly, corrosion-resistant according to the criteria of the Kesternich test. The printing layer may also not be detachable from the information medium by gluing on and removing an adhesive film. In addition, the printing layer can be free of defects and/or craters due to the treatment with at least one plasma. This is because the treatment with the at least one plasma can remove interfering substances. These can in particular be substances which impair wetting of the base body with the printing layer—for example, substances which interfere with lacquer wetting.

The method is suitable for producing an information medium described herein, but is not limited thereto.

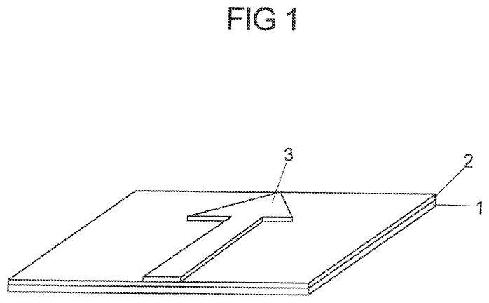

FIG. 1 shows an information medium with a base body 1, which has a surface 10, which is printed at least in sections with a printing layer 3. The printing layer 3 represents information in the form of an arrow. In principle, the printing layer 3 can represent any type of information—in particular, also numbers, letters, or characters. The base body 1 is designed to be flat and rectangular. In principle, the base body 1 can be any shape.

An adhesion-promoting layer 2 is arranged on the surface 10 of the base body 1. The printing layer 3 is arranged on the base body 1 over the adhesion-promoting layer 2. The adhesion-promoting layer 2 covers one side of the base body 1, on which the printing layer 3 is arranged. Thus, the adhesion-promoting layer 2 is located on the printing layer 3 between the base body 1 and the printing layer 3. In principle, several sides—in particular, a front and rear side of the base body 1—or all sides of the base body 1, can be covered with the adhesion-promoting layer 2.

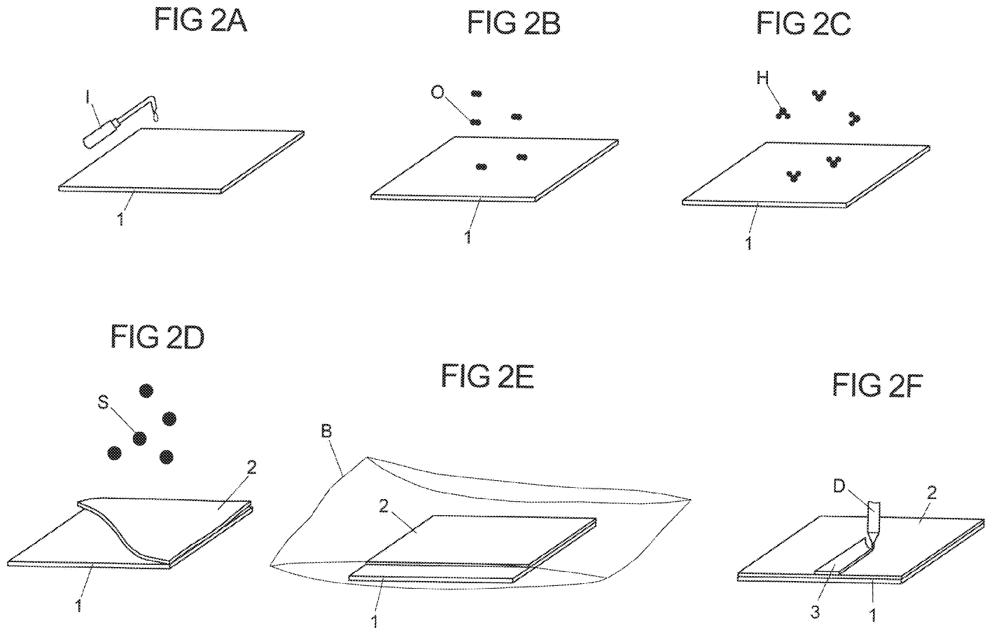

FIGS. 2A through 2F show steps of a method for producing an information medium. The method can be carried out according to the sequence of the figures.

FIG. 2A illustrates a cleaning step in which a provided base body 1 is cleaned with a cleaning agent I. The cleaning agent I can be a liquid, e.g., a solvent, such as, for example, isopropanol. The cleaning agent I can remove oils, fats, fibers, organic compounds, and other impurities. The cleaning step can in principle comprise mechanical and/or chemical cleaning.

FIG. 2B illustrates a subsequent, further cleaning step in which a surface 10 of the base body 1 is cleaned with an oxygen plasma O. Further impurities can be removed from the base body 1 with the oxygen plasma O.

In a step illustrated in FIG. 2C, the surface 10 of the base body 1—after the cleaning steps according to FIGS. 2A and 2B—is activated with a water plasma H so that the reactivity of the surface is increased. In particular, surface oxides can also be removed by the water plasma H. In principle, instead of the water plasma H—an H₂O plasma—a hydrogen plasma, can likewise be used.

In a step illustrated in FIG. 2D, an adhesion-promoting layer 2 is applied to at least one section of the base body 1. To this end, a starting material S is brought into the gaseous phase and ionized with a plasma. The starting material S can, for example, be 3-(trimethoxysilyl)propyl methacrylate. The adhesion-promoting layer 2 is applied by polymerizing the starting material S on the surface 10 of the base body 1. The starting material S thus forms polymer compounds on the surface 10. In general, the adhesion-promoting layer 2 can be applied to a part or to the entire surface 10 of the base body 1.

In a step illustrated in FIG. 2E, the information medium is stored for a period of one or more weeks—for example, 1 to 12 months. To protect the adhesion-promoting layer 2, the information medium is enclosed in a container B. As a result, the adhesion-promoting layer 2 is protected from impurities, which easily adhere to the adhesion-promoting layer 2. In the exemplary embodiment shown, the container B is formed by a PE bag. The information medium can be stored in it for, for example, seven weeks at room temperature. In principle, the adhesion-promoting layer 2 can likewise be protected by covering the adhesion-promoting layer 2 with a barrier film, or by shrink wrapping or laminating the information medium.

In a printing step illustrated in FIG. 2F and carried out after storage, a printing layer 3 is applied to a section of the adhesion-promoting layer 2. The printing layer 3 is applied to the adhesion-promoting layer 2 using a printing device D. In the exemplary embodiment shown, the printing device D is formed by an inkjet printing head. The printing device D discharges at least one colorant, from which the printing layer 3 is formed for displaying information.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Base body
10 Surface
2 Adhesion-promoting layer
3 Printing layer
B Container
D Printing device
G Object
H Water plasma
I Cleaning agent
O Oxygen plasma
S Starting material

1. An information medium, comprising:
a base body, which has a surface that is printable at least in sections with a printing layer for displaying information,
wherein an adhesion-promoting layer is arranged on at least some sections of the surface.

2. The information medium of claim 1, wherein the base body is inorganic.

3. The information medium of claim 1, wherein the adhesion-promoting layer comprises a molecular compound with a first functional group configured to bind to the surface and a second functional group configured to bind to the printing layer.

4. The information medium of claim 3, wherein the first functional group comprises a phosphate or silane group.

5. The information medium of claim 3, wherein the second functional group comprises an acrylate group.

6. The information medium of claim 1, wherein the adhesion-promoting layer comprises a silicon compound comprising a silane compound.

7. The information medium of claim 1, wherein the adhesion-promoting layer comprises at least one acrylate comprising at least one silyl group.

8. The information medium of claim 1, wherein the adhesion-promoting layer comprises at least one 3-(trimethoxysilyl)propyl acrylate.

9. The information medium of claim 1, wherein the adhesion-promoting layer comprises a molecule 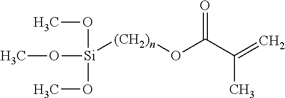
wherein n≥0.

10. The information medium of claim 1, further comprising:
a printing layer bonded to the base body by the adhesion-promoting layer.

11. The information medium of claim 10, wherein the printing layer comprises at least one acrylate.

12. The information medium of claim 10, wherein the printing layer comprises a UV-curable fluid.

13. A method for producing an information medium, comprising the following steps:
providing a base body;
applying an adhesion-promoting layer at least to sections of the base body; and
applying a printing layer at least to sections of the adhesion-promoting layer.

14. The method of claim 13, wherein, before applying the adhesion-promoting layer, the method further comprises:
treating the base body with at least one plasma comprising an oxygen plasma and/or a water plasma.

15. The method of claim 13, wherein applying an adhesion-promoting layer comprises applying the adhesion-promoting layer by plasma polymerization and/or in a vacuum.

16. The method of claim 13, wherein, between applying an adhesion-promoting layer and applying the printing layer, the method further comprises:
storing the information medium for a period of more than one week.

17. The method of claim 13, further comprising:
curing the printing layer with UV light after applying the printer layer.

18. The method of claim 16, wherein the period of more than one week comprises several weeks.
